(19) United States
(12) Patent Application Publication
(10) Pub. No.: US 2007/0038485 A1
(43) Pub. Date: Feb. 15, 2007

(54) Method and automated system for evaluating and trading insurance risk

(76) Inventors: Luke W. Yeransian, Omaha, NE (US); Anupama V. Murthy, Omaha, NE (US)

Correspondence Address: Bryan K. Wheelock, Suite 400, 7700 Bonhomme, St. Louis, MO, 63105, US

(21) Appl. No.: 11/483,395

(22) Filed: Jul. 7, 2006

Related U.S. Application Data
(60) Provisional application No. 60/697,400, filed on Jul. 7, 2005.

(51) Int. Cl. G06Q 40/00

(52) U.S. Cl. 705/4

(57) ABSTRACT

Automated system used by an insurance carrier that is used by carrier for evaluating insurance risk and for setting optimal premiums for policies where the carrier's underwriters act as traders of the risk by relying on the system to determine whether to issue policies and to determine a range of appropriate premiums.

### CROSS-REFERENCE TO RELATED APPLICATIONS

This application claims the benefit of U.S. Provisional Patent Application Ser. No. 60/697,400, filed Jul. 7, 2005, the entire disclosure of which is incorporated herein by reference.

### FIELD

The present invention relates to the field of insurance. More particularly, the invention relates to a system for collecting insurance information, providing premium quotations, either automatically or through a totally automated, task-based work flow process that enables underwriters to evaluate the risk and then enables the system to communicate on a real time basis with agents as to either (a) an optimal price for of the insurance policy or (b) the denial of coverage. The risk analysis is based on set proprietary underwriting criteria of the insurance carrier, which provides a detailed method for analyzing and pricing the risk of a particular insured. A patent is not being claimed for a set of underwriting criteria.

### BACKGROUND

Insurance carriers are faced with the task of systematically being required to evaluate risk presented by a particular insured's business and business activity. As with all types of insurance, this process for evaluating the risk associated with the proposed insured and their business or business activity adds to the time and cost of insurance. To obtain insurance, potential insureds typically utilize agents that act on behalf of an insurance carrier. The insurance carrier issues insurance policies based on its comfort level with the risk posed by the information pertaining to the business or business activity. The premium charged for a particular policy is dependent upon the level of risk posed by the particular classification of insurance. In order to assess the risk and determine whether a particular risk may be insured (and the premium associated with such insurance), insurance carriers have historically used underwriters who are individuals with expertise in assessing risk based on a number of factors. These underwriters normally work in conjunction with insurance agents to collect data representing the factors which affect the risk associated with a particular business or business activity. To facilitate this process, insurance carriers develop underwriting rules for different classifications of insurance that are normally used by a carrier's underwriters to determine whether to insure the risk and to assign a premium to the risk. These underwriting rules are often proprietary to a carrier. The process of obtaining a risk analysis and subsequent insurance premium quotations or policy quotes for a carrier is often quite complex and requires the underwriters to undergo a detailed evaluation using the carrier's underwriting rules. This process can be very labor intensive and time consuming, often lacking controls or checks and balances to ensure that the carrier's risk comfort level is aligned with the actual risk it ends up writing.

In an effort to expedite the risk analysis process, many insurance carriers have attempted to automate the method for collecting insurance information and issuing policy quotations as possible. Notwithstanding attempts to automate this process, insurance carriers are often forced to divert the analysis of risk from their automated systems to underwriters for additional analysis outside of the normal automated work flow (a manual system). This analysis does not allow for real time communication with agents, thereby increasing the amount of time required to determine the acceptable premium amount for a policy or to deny coverage. A manual process also increases the chances of offering quotes for risks that are outside of the carrier's underwriting/risk parameters (due to lack of controls of underwriting authorities). Therefore, there is a need for a web-based automated system that simplifies the process of analyzing risk, establishes a task based work flow process that enables underwriters to analyze risk within the context of the automated system and that allows the system to communicate the determination of coverage and pricing information developed from the task based work flow process in real time with agents while maintaining pricing and underwriting controls predetermined by the carrier. This system thereby facilitates an expedited, yet accurate, means of obtaining insurance quotations from an insurance carrier which decreases the time necessary for analysis and decreases the transaction costs associated with that process.

### SUMMARY

The invention relates to an automated system used by an insurance carrier that is used by carrier for evaluating insurance risk and for setting optimal premiums for policies where the carrier's underwriters act as traders of the risk by relying on the system to determine whether to issue policies and to determine a range of appropriate premiums. The automated system is used to (i) determine an acceptable premium quotation for an insurance policy, (ii) deny coverage for a potential insured or, in the event the system is unable to determine (i) or (ii), (iii) provide for a totally automated, task based work flow process that enables underwriters of the carrier to act as traders of the risk, evaluating risk and communicating on a real time basis with agents as to either (a) an acceptable price for the insurance policy based on an optimal price determination by the system (using minimums and indicated premium ranges derived from a carrier's proprietary pricing methodology), or (b) the denial of coverage. The system has integrated controls which operate to dictate the work flow and place checks and balances on the system's users, including underwriters, to make sure that no user exceeds an authority level established by the carrier and that all matters are escalated to the appropriate level of authority within the insurance carrier for resolution. No insurance risk is quoted until the risk is fully evaluated by the system in this method. All risk analysis is based on a set of proprietary underwriting criteria determined by the insurance carrier based on particular risks (both pricing and underwriting) for the potential insured. A patent is not being claimed on any proprietary underwriting criteria used by an insurance carrier. The collective effect of automated system is a process for evaluating insurance risk and trading the risk through pricing of an insurance policy and supporting the underwriting process and the carrier's agents through out the automated, web-based, paperless application process.

### BRIEF DESCRIPTION OF THE DRAWINGS

The present invention will become more fully understood from the detailed description and the accompanying drawings, wherein:

FIG. 1 is a flow chart of a preferred embodiment of a method in accordance with the principles of this invention.

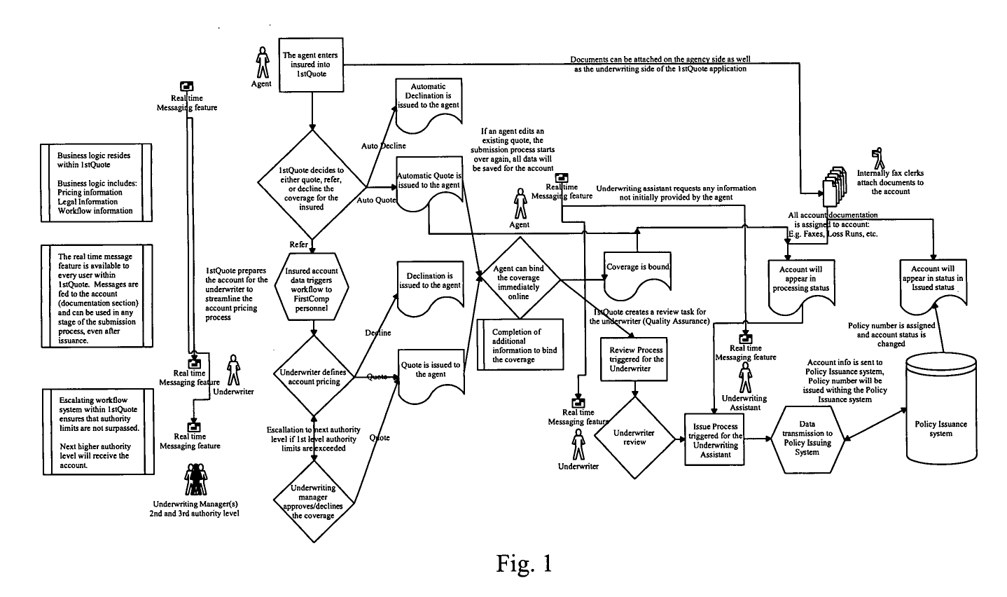

### DETAILED DESCRIPTION

A method and automated system for collecting insurance information, providing premium quotations, either automatically or through a totally automated, task based work flow process that enables underwriters to evaluate the risk and communicate on a real time basis with agents as to either (a) an acceptable price for of the insurance policy or (b) denial of coverage. The system has two critical aspects. One aspect of the present invention relates to the agent's ability to input risk information into an automated system using a web-based agent interface and receive, on a real time basis, either an immediate quote for an insurance policy or notification of denial of coverage. This method involves the analysis of information input by agents into the system using predetermined underwriting and pricing rules to determine the appropriate outcome. This requires no human/underwriter intervention.

The other aspect of the system is, in the event the risk cannot be quoted based immediately on a real-time basis by the system, the risk is directed into an automated, task based work flow process that engages an underwriter of the insurance carrier in to the risk analysis on a real time basis. This aspect of the system allows for an underwriter to obtain information necessary to maximize the pricing of a policy and select a price quotation within the carriers predetermined minimum and indicated price ranges (optimal price) that adequately provides for the risk associated with the particular insured. The key element of this aspect is that the underwriting process is fully automated and allows for the entire process, from additional information collection through analysis of additional risk factors, to be done within the automated system, thereby allowing the insurance carrier to be in constant real time communication with its agents and providing underwriters with a system it can use to maximize the amount of information collected from the agent, the quality of the information collected from the agent and accuracy of risk analysis and pricing. Because the system provides for this real time information collection and provides underwriter with a task based work flow to follow to gather only relevant information, it enables the insurance carrier, through the underwriter, to maximize the pricing for any given policy and to maximize the efficiency of the underwriting process. Through the creation of this real time process, the insurance carrier is better able to serve its agents, encourage efficient communications and issue more accurate quotations. All of these results maximize the profit of the insurance carrier.

Other features and advantages of the present invention are apparent to one skilled in the art upon examination of the following drawings. It is intended that all such features and advantages be included herein within the scope of the present invention.

A method and automated system for collecting insurance information, providing premium quotations, either automatically or through a totally automated, task based work flow process that enables underwriters to evaluate the risk and communicate on a real time basis with agents as to either (a) an optimal price for of the insurance policy or (b) denial of coverage. The system has two critical aspects. One aspect of the present invention relates to the agent's ability to input risk information into an automated system using a web-based agent interface and receive, on a real time basis, either an immediate quote for an insurance policy or notification of denial of coverage. This method involves the analysis of information input by agents into the system using predetermined underwriting rules to determine the appropriate outcome. The method and automated system commences its risk analysis upon receipt of underwriting information input by agent through a web-based agent interface. The underwriting information is submitted for the purpose of a premium quotation. The information is received by the automated system and is stored in a database. The automated system reviews the information against underwriting rules to evaluate risk and, alternatively, either returns a premium quotation, denies coverage and does not return a quotation or submits the information to a task-based work flow process that enables an underwriter to evaluate the information on a real time basis and maximize the pricing for the policy. It is the ability of the system to submit the information for further review through the task based work flow process and ultimately either select a price quotation within the carrier's predetermined minimum and indicated optimal price or deny coverage that comprises the other aspect of the system. In either case, the agent may utilize the price quotation returned by the system to place a policy. The expeditious, real time nature of the system enables the insurance carrier and its agents to more efficiently write business, thereby maximizing revenues.

What is claimed is:

1. An automated system used by insurance carrier for evaluating insurance risk based on underwriting information comprising an agent interface; a database comprising underwriting information and associated underwriting rules established by a carrier; and an automated system connected to the agent interface and the database through a network wherein the automated system receives insurance information from the agent interface, stores the insurance information on the database, retrieves the respective underwriting rules from the database, and processes the insurance information as set out herein.

2. The method and automated system of claim 1 begins to perform an analysis of insurance risk upon receipt of underwriting information input by an agent through the systems automated, web-based, paperless agent interface.

3. The system of claim 1 performs a risk analysis against underwriting and pricing rules, wherein, in response to the system analysis, a premium quotation is issued or a denial of coverage is issued, all based on the automated system's risk assessment with no human/underwriter involvement

4. The system of claim 3, wherein the automated system transmits the premium quotation to the agent interface for display to an agent.

5. The system of claim 4, wherein the automated system may subsequently receive an acceptance of the premium quotation via the agent interface.

6. The system of claim 1, wherein, in response to an automated determination by the system that a premium quotation may not be issued for any of several reasons related to the underwriting rules, the automated system forwards the underwriting information to an automated, paperless, task based work flow process within the system that prompts an underwriter to, in effect, act as traders of the insurance risk, thereby using the automated system to: (i) analyze information and to communicate, if necessary, on a real time basis with the agent to gather additional information to determine the optimal price for a policy and/or (ii) escalate a review of submitted risks to various decision makers within the carrier, based on a set of controls whereby any user may not exceed his authority in regard to the risk evaluation process, to determine the optimal price for a policy or whether to deny coverage. The key element of this claim is that the underwriting process is fully automated and allows for the entire process, from additional information collection through analysis of additional risk factors by underwriter, to be done within the automated system, thereby allowing the insurance carrier to be in constant real time communication with its agents through the system and providing underwriters with a system it can use to maximize the amount of information collected from the agent in the most expeditious manner possible.

7. An automated system of claim 1 used by insurance carrier, in accordance with claim 6, to determine whether a premium quotation may be issued for carrier.

8. The system of claim 7, wherein, in response to a determination by the underwriter acting as a trader of the risk, the system sets an optimal premium through use of the task based work flow process described in claim 6 and issues a premium quotation to the agent based on the optimal premium for the carrier.

9. The system of claim 8, wherein the automated system transmits an acceptable premium to the agent interface for display to agent.

10. The system of claim 9, wherein the automated system may receive an acceptance of the premium quotation and issues a binder based on the premium quotation.

11. An automated system of claim 1 used by insurance carrier for interactively evaluating insurance risk based on underwriting information comprising: an agent interface; a database comprising underwriting information comprising multiple underwriting and pricing rules established by a carrier; and an automated system connected to the agent interface and the database through a network wherein the automated system receives insurance information from the agent interface, stores the insurance information on the database, retrieves the respective underwriting and pricing rules from the database, and processes the insurance information in accordance the method set out in claim 6 and determines that the carrier should issue a denial of coverage.

12. The method of claim 11, further determining that a denial of coverage is appropriate, transmits the information to the agent interface for display to an agent.
